(19) United States
(12) Patent Application Publication
(10) Pub. No.: US 2026/0142345 A1
(43) Pub. Date: May 21, 2026

(54) SECONDARY BATTERY AND METHOD OF MANUFACTURING THE SECONDARY BATTERY

(71) Applicant: SAMSUNG SDI CO., LTD., Yongin-si (KR)

(72) Inventors: Dong Hyun KIM, Yongin-si (KR); Ye Jin SEO, Yongin-si (KR); Eun Jeong MOON, Yongin-si (KR)

(21) Appl. No.: 19/215,552

(22) Filed: May 22, 2025

(30) Foreign Application Priority Data
Nov. 21, 2024 (KR) 10-2024-0166794

(51) Int. Cl. H01M 50/533; H01M 10/0585; H01M 50/105; H01M 50/54; H01M 50/586; H01M 50/595

(52) U.S. Cl. CPC H01M 50/533; H01M 10/0585; H01M 50/105; H01M 50/54; H01M 50/586; H01M 50/595

(57) ABSTRACT

A secondary battery includes an electrode assembly in which a positive electrode plate, a negative electrode plate, and a separator are stacked, a case that wraps around the outside of the electrode assembly, and an electrode lead having a first side electrically connected to an electrode tab of the electrode assembly and a second side extending outward from the case, the electrode lead including a bent portion positioned inside of the case. The electrode lead includes a connection body fixed to the electrode tab, and an extension body bent at a set angle from the connection body and extending outward from the case, and the set angle is equal to or less than about 90°.

### CROSS-REFERENCE TO THE RELATED APPLICATION

The present application claims priority to and the benefit of Korean Patent Application No. 10-2024-0166794, filed on Nov. 21, 2024, in the Korean Intellectual Property Office, the entire disclosure of which is incorporated herein by reference.

### BACKGROUND

### 1. Field

Embodiments relate to a secondary battery and a method of manufacturing the secondary battery.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the invention and therefore it may contain information that does not constitute prior art.

### SUMMARY

Aspects of embodiments of the present disclosure provide a secondary battery that includes electrode lead connected to an electrode tab of an electrode assembly and not is not bent at an obtuse angle and a method for manufacturing the secondary battery.

Other aspects of some of the present disclosure provide a secondary battery that has efficient space utilization because an electrode lead is bent at an acute angle or a right angle in a process that reduces rigidity of the electrode lead in a stack-type electrode assembly a method for manufacturing the secondary battery.

However, the technical problems to be achieved in the embodiment of the disclosure are not limited to the technical problems mentioned above, and other technical problems not mentioned herein will be clearly understood from the following description by those skilled in the art to which the disclosure belongs.

According to some embodiments, a secondary battery includes: an electrode assembly in which a positive electrode plate, a negative electrode plate, and a separator are stacked; a case that wraps around the outside of the electrode assembly; and an electrode lead having a first side electrically connected to an electrode tab of the electrode assembly and a second side extending outward from the case, the electrode lead including a bent portion positioned inside of the case.

In some embodiments, the electrode lead may include: a connection body fixed to the electrode tab; and an extension body bent at a set angle from the connection body and extending outward from the case.

In some embodiments, the set angle may be equal to or less than about 90°.

In some embodiments, the electrode lead may be bent to the set angle by movement of a working roller while the electrode lead is connected to the electrode tab.

In some embodiments, the electrode lead may be softened by being pressed by the working roller.

In some embodiments, the pressing by the working roller is a first pressing, and after the first pressing by the working roller, the electrode lead may be bent to the set angle by a second pressing of the working roller.

In some embodiments, a lower side of the electrode lead may be supported by a lower jig and a bottom jig during the first pressing by the working roller.

In some embodiments, in the second pressing by the working roller, a portion of a lower side of the electrode lead is supported by the lower jig, and the working roller may move along an upper edge of the lower jig to bend the electrode lead protruding to outside of the lower jig.

In some embodiments, the upper edge of the lower jig is formed at a right angle, and the electrode lead that is in contact with the upper edge may be bent at about 90° by the second pressing of the working roller.

In some embodiments, the upper edge of the lower jig is formed at an acute angle, and the electrode lead that is in contact with the upper edge may be bent to an acute angle by the second pressing of the working roller.

In some embodiments, the secondary battery may further include an insulating tape disposed between the electrode lead and the case and being fixed to an outside of the electrode lead.

According to some embodiments, a method for manufacturing a secondary battery includes: a connection process of connecting an electrode lead to an electrode tab that protrudes outward from an electrode assembly in which a positive electrode plate, a negative electrode plate, and a separator are stacked; a first pressing process of pressing the electrode lead by movement of a working roller to soften the electrode lead; and a second pressing process of pressing the electrode lead by the working roller to bend the electrode lead to a set angle.

In some embodiments, the first pressing process may include: a first process of pressing the electrode tab connected to the electrode lead downward due by a descending front guide; a second process of supporting the electrode lead by a base jig; and a third process of pressing the electrode lead upward by the working roller.

In some embodiments, the base jig may include: a lower jig supporting a first side of the electrode lead connected to the electrode tab; and a bottom jig disposed at a second side of the lower jig to support the other side of the electrode lead.

In some embodiments, the second pressing process may include: a first moving process of moving the bottom jig supporting the electrode lead downward; and a second moving process of moving the working roller downward to bend the electrode lead while the electrode jig is hung on the bottom jig.

In some embodiments, the lower jig may have a rectangular cross-section, and the electrode lead may be bent in a shape that wraps an upper edge of the lower jig.

In some embodiments, a bending angle of the electrode lead may be about 90°.

In some embodiments, the lower jig may have an inverted triangular cross-section, and the electrode lead may be bent in a shape that wraps an upper edge of the lower jig.

In some embodiments, a bending angle of the electrode lead may be an acute angle.

In some embodiments, the second pressing process may further include a restriction process that restricts movement of the electrode tab connected to the electrode lead due to the descending of the front guide.

In some embodiments, the method may further include a moving process of moving the electrode lead to be disposed in front of the electrode assembly after the second pressing process is complete.

In some embodiments, the moving process may include: a release process of releasing restriction of the electrode tab by ascension of a front guide; and a jig moving process of moving a jig in a direction toward the electrode assembly.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view of a secondary battery according to embodiments of the present disclosure;

FIG. 2 is a perspective view of a state in which an electrode assembly is separated from a case according to embodiments of the present disclosure;

FIG. 3 is a cross-sectional view of a state in which an electrode lead inside is bent at a right angle;

FIG. 4 illustrates a flowchart of a method for manufacturing a secondary battery according to embodiments of the present disclosure;

FIG. 5 is a perspective view of a state in which the electrode lead is softened according to embodiments of the present disclosure;

FIG. 6 is a front view of the state in which the electrode lead is softened according to embodiments of the present disclosure;

FIG. 7 is a front view of a state in which a bottom jig descends according to embodiments of the present disclosure;

FIG. 8 is a front view of a state in which the electrode lead is bent due to movement of a working roller according to embodiments of the present disclosure;

FIG. 9 is a front view of a state in which the electrode lead moves to a front side of the electrode assembly according to embodiments of the present disclosure;

FIG. 10 is a perspective view of the working roller according to embodiments of the present disclosure;

FIG. 11 is an enlarged perspective view of a rotating roller of the working roller according to embodiments of the present disclosure;

FIG. 12 is a cross-sectional view of a state in which an electrode lead inside a case is bent at an acute angle;

FIG. 13 is a front view of a state in which the electrode lead is softened;

FIG. 14 is a front view of a state in which a bottom jig descends;

FIG. 15 is a front view of a state in which the electrode lead is bent due to movement of a working roller;

FIG. 16 is a front view of a state in which the electrode lead moves to a front side of an electrode assembly;

FIGS. 17A and 17B are perspective views of a battery pack including a secondary battery according to embodiments of the present disclosure; and

FIGS. 18A and 18B are perspective and side views of a vehicle including a battery pack according to embodiments of the present disclosure.

### DETAILED DESCRIPTION

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, The attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

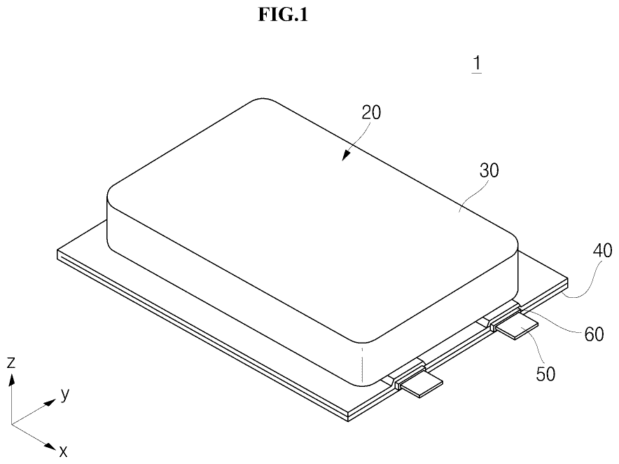

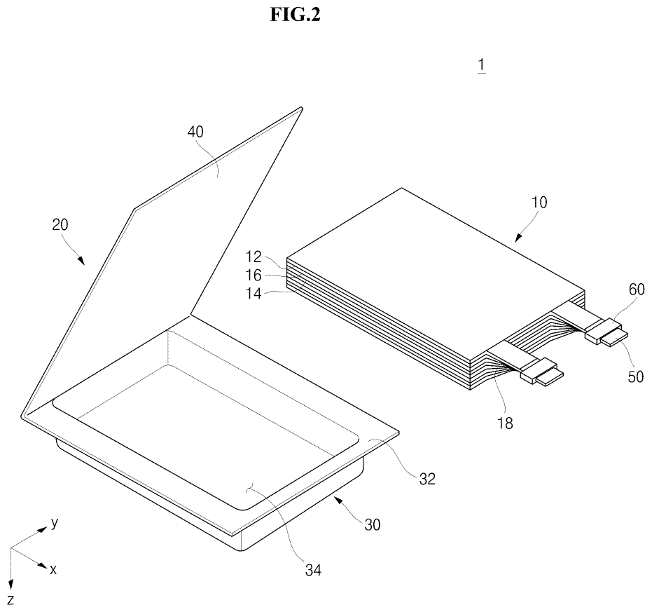

FIG. 1 is a perspective view of a secondary battery 1 according to embodiments of the present disclosure, and FIG. 2 is a perspective view of a state in which an electrode assembly 10 is separated from a case 20 according to embodiments of the present disclosure. As illustrated in FIGS. 1 and 2, a secondary battery 1 according to embodiments may include an electrode assembly 10 and an electrode lead 50. In some embodiments, the secondary battery 1 may further include a case 20 and an insulating tape 60.

If the electrode lead 50 is not bent to a set angle (for example, because of rigidity of the electrode lead 50), electrical safety may be reduced when the electrode lead 50 and the electrode assembly 10 are in contact with each other. In some embodiments, because the electrode lead is bent (for example, after being softened), interference between the electrode lead 50 and the electrode assembly 10 may be prevented to thereby improve electrical safety.

The electrode assembly may be formed in various shapes constituting a stack in which a positive electrode plate 12, a negative electrode plate 14, and a separator 16 are alternately stacked. In some embodiments, the electrode assembly 10 may be provided in the form of a roll in which a negative electrode part, a positive electrode part, and a separator 16 are wound. The electrode assembly 10 according to embodiments may be provided with an electrode tab 18, which is accommodated in the case 20 and is provided with the positive electrode plate 12, the negative electrode plate 14, and the separator 16 disposed between the positive electrode plate 12 and the negative electrode plate 14. In the present disclosure the case 20 may be referred to as a pouch.

The electrode assembly 10 may be accommodated inside the pouch together with the electrolyte. The electrolyte may be, for example, a lithium salt such as LiPF6, LibF4, etc., in an organic solvent such as ethylene carbonate (EC), propylene carbonate (PC), diethyl carbonate (DEC), ethyl methyl carbonate (EMC), dimethyl carbonate (DMC), etc.

The positive electrode plate 12 may be provided with a positive electrode tab 18 electrically connected to a non-coated portion of the positive electrode, and the negative electrode plate 14 may be provided with a negative electrode tab 18 electrically connected to a non-coated portion of the negative electrode. The electrode tab 18 may be welded to the electrode lead 50 and electrically connected to outside of the battery. The insulating tape 60 may be attached to the electrode lead 50 for insulation from the pouch.

The positive electrode plate 12 may be provided in the form of a plate made of aluminum (Al) and coated with transition metal oxide on at least one surface of the positive electrode plate 12. In some embodiments, the non-coating portion, where the positive electrode active material is not applied, may be provided at one side of the positive electrode plate 12.

The negative electrode plate 14 may be provided in the form of a plate made of copper (Cu) or nickel (Ni) and be coated with a negative electrode active material such as graphite or carbon on at least one surface thereof. In some embodiments, the non-coating portion, where the negative electrode active material is not applied, may be provided at one side of the negative electrode plate 14.

The separator 16 may be made of polyethylene (PE) or polypropylene (PP), but the present disclosure is not limited to these examples. The separator 16 may prevent electrical short between the positive electrode plate 12 and the negative electrode plate 14 and enable movement of lithium ions between the plates 12 and 14.

The case 20 may be formed in various shapes that surround the outside of the electrode assembly 10. In the present disclosure, the case 20 may be a pouch made of a soft film. The pouch may be provided with a case body 30 and a case cover by folding a rectangular film to extend in a first direction x.

After the electrode assembly 10 is accommodated in a recess 34 provided in the case body 30, the case cover 40 may be moved to cover an opening of the case body 30. But the pouch is not limited to the integrated form in which the case body 30 and the case cover 40 are provided as a single film. However, for convenience, the following description will be directed to an embodiment where the case body 30 and the case cover 40 are formed from a single rectangular film.

In some embodiments, the case body 30 may include the recess 34 and a sealing part 32. The case body 30 may be provided with the recess 34 in which the electrode assembly 10 is accommodated at a center of the case body 30, and the case body 30 may include the sealing part 32 extending outward from three sides of the recess 34.

The sealing part 32 may be a surface that is parallel to and coupled to the case cover 40. For example, if the case body 30 and the case cover 40 are provided as separate members, the sealing part 32 may extend outward from the four sides of the recess 34. In some embodiments, even if the case body 30 and the case cover 40 are integrated with each other, the sealing part 32 may extend outward from the four sides of the recess 34.

The case cover 40 and the case body 30 may be provided as a multilayer thin film including a thin metallic film with insulating layers disposed on sides of the thin metallic film. The case cover 40 and the case body 30 may define surfaces that are in contact with each other as inner surfaces and opposite surfaces as outer surfaces.

The recess 34 of the case body 30 may be sized to accommodate the electrode assembly 10 by pressing, drawing processing, etc. In the case body 30, an edge of the recess 34 and an edge of the case cover 40 may be thermally fused to each other after the case cover 40 covers recess 34. More specifically, the pouch may be sealed by sealing an edge area of the case body 30 and an edge area of the case cover 40 after the electrode assembly 10 is accommodated in the recess 34.

The edge of the case body 30 disposed on the outer side of a plane with respect to the recess 34 that is sealed with the edge of the case cover 40 may be defined as the sealing part 32. An inner surface of the pouch may have a thermal fusion layer made of a thermal fusion material.

The case cover 40 may have a rectangular flat shape. And the case cover 40 may be connected to the case body 30 to cover an upper portion of the case body 30 by a folding operation.

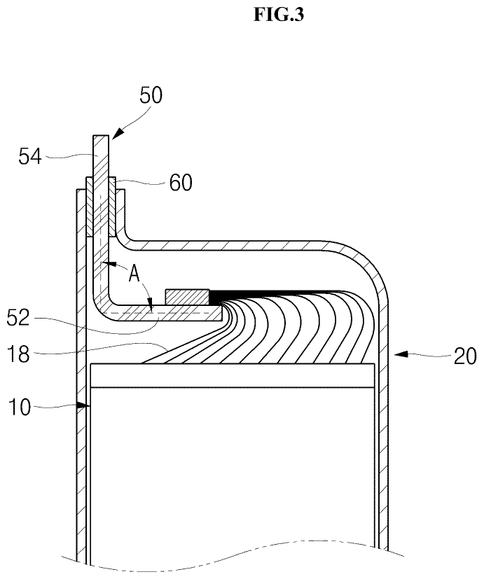

FIG. 3 is a cross-sectional view in which the electrode lead 50 is positioned inside the case 20 while being bent at a right angle. As illustrated in FIG. 3, one side of the electrode lead 50 may be electrically connected to the electrode tab 18 of the electrode assembly 10, and the other side of the electrode lead 50 may extend to outside of the case 20. In the electrode lead 50, the part disposed inside the case 20 may be made in various bent shapes.

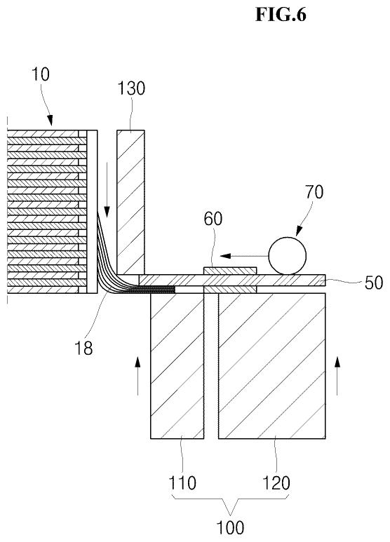

The electrode lead 50 according to some embodiments may be bent at a set angle A. The electrode lead 50 may be bent by various means, such as being bent by pressing of a working roller 70 (see FIG. 6). In the present disclosure, the set angle A may be referred to as a bending angle. The electrode lead may include an extension body 54 extending outward from the case 20 and a connection body 52 bent at the set angle A from the extension body 54. The electrode tab 18 of the electrode assembly 10 may be fixed to the connection body 52 by welding or the like.

Each of the extension body 54 and the connection body 52 may be provided in a straight line. In a state in which movement of the connection body 52 is restricted, the extension body 54 may be bent at the set angle A. In some embodiments, various deformations such as the bending of the connection body 52 at the set angle A may be implemented in the state wherein the movement of the extension body 54 is restricted.

For example, the bending angle of the electrode lead 50 may be equal to or less than about 90°. If the angle formed by the connection body 52 and the extension body 54 is set to about 90° or less, electrical limitations, such as a short circuit occurring by the connection body 52 contacting the electrode assembly 10, may be prevented.

If the angle formed by the connection body 52 and the extension body 54 is about 90°, the extension body 54 and an upper end of the electrode assembly 10 (as shown in FIG. 3) may be installed parallel to each other to improve the electrical safety.

The electrode lead 50 may be bent to the set angle A by movement of the working roller 70 (described below) while being connected to the electrode tab 18. The electrode lead 50 may be bent to the set angle A by primary pressing of the working roller 70. In embodiments where the rigidity of the electrode lead 50 is strong, the working roller 70 may move several times to bend the electrode lead 50 to the set angle A. For example, the electrode lead 50 may be softened by a first pressing of the working roller 70 and bent to the set angle A by a second pressing of the working roller 70. If the first pressing of the working roller 70 is performed, a lower side of the electrode lead 50 may be supported by a lower jig 110 and a bottom jig 120 (described below).

The insulating tape 60 may be disposed between the electrode lead 50 and the case 20 and may be deformed into various shapes that are fixed to the outside of the electrode lead 50. The insulating tape 60 may be installed on both surfaces of the electrode lead 50 facing the case 20. Because the insulating tape 60 is provided, the electrical connection between the electrode lead 50 and the case 20 may be blocked.

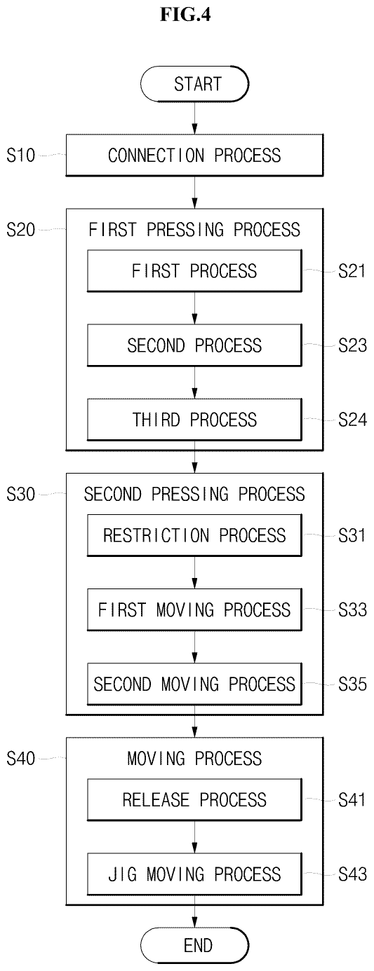

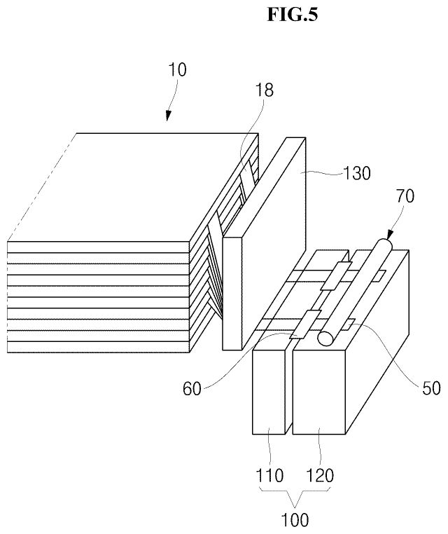

FIG. 4 is a flowchart of a method for manufacturing a secondary battery 1 according to embodiments of the present disclosure, FIG. 5 is a perspective view of a state in which an electrode lead 50 is softened according to embodiments of the present disclosure, and FIG. 6 is a front view of the state in which the electrode lead 50 is softened according to embodiments of the present disclosure. As illustrated in FIGS. 4 to 6, a method for manufacturing a secondary battery 1 according to embodiments may include a connection process S10, a first pressing process S20, a second pressing process S30, and a moving process S40.

In the connection process S10, the electrode lead 50 may be connected to an electrode tab 18 protruding outside of an electrode assembly 10 in which a positive electrode plate 12, a negative electrode plate 14, and a separator 16 are stacked. The electrode tab 18 and the electrode lead 50 may be fixed using various fixing methods, such as welding. The connection between the electrode lead 50 and the electrode tab 18 may be performed in a state in which an insulating tape 60 is fixed to the outside of the electrode lead 50. In addition, various modifications may be possible, such as connecting the electrode lead 50 and the electrode tab 18 without the insulating tape 60 being provided.

The first pressing process S20 may be a process in which a working roller 70 moves to first press the electrode lead 50 and thereby softens the electrode lead 50.

A front guide 130 may be movable in a vertical direction and be disposed at an upper side of the electrode tab 18 connected to the electrode lead 50. The front guide 130 may be formed into various shapes that are capable of restricting movement of the electrode tab 18. For example, the front guide 130 may be a square plate shape, but the present disclosure is not limited to this example and the front guide 130 may be formed in various shapes. In some embodiments, the front guide 130 may be moved by a robot arm or a pneumatic actuator.

In some embodiments, a lower jig 110 (see FIG. 5) is positioned below the front guide 130 such that the electrode tab 18 may be disposed between the front guide 130 and the lower jig 110.

A lower portion of the electrode lead 50 connected to the electrode tab 18 may be supported by a base jig 100. The base jig 100 may be provided as a single member or, if necessary, the base jig 100 may be provided as a plurality of members. The base jig 100 according to some embodiments may include the lower jig 110 that supports one side of the electrode lead 50 connected to the electrode tab 18 and a bottom jig 120 that is disposed at a side of the lower jig 110 to support the other side of the electrode lead 50.

Each of the lower jig 110 and the bottom jig 120 may be formed as a hexahedral jig or may be formed in various other shapes. The lower jig 110 and the bottom jig 120 may be positioned horizontally side by side. In some embodiments, because the lower jig 110 and the bottom jig 120 are connected to different driving devices, movements of the lower jig 110 and the bottom jig 120 may be performed individually. The lower jig 110 and the bottom jig 120 have to have sufficient strength to support the electrode lead 50 and are disposed at a position so that the electrode lead 50 is stably softened when the electrode lead 50 is pressed by the working roller 70.

In the first pressing process S20, the front guide 130 may be positioned to restrict the movement of the electrode tab 18, and the lower jig 110 and the bottom jig 120 may support the lower side of the electrode lead 50. In some embodiments, the working roller 70 is disposed at an upper side of the bottom jig 120 and may press the upper side of the electrode lead 50 to move toward the front guide 130, thereby softening the electrode lead 50. The electrode lead 50 may be uniformly softened by the pressing and movement of the working roller 70 to prepare it for a subsequent smooth bending process.

The first pressing process S20 according to embodiments may include a first process S21, a second process S23, and a third process S24.

The first process S21 include pressing the electrode tab 18 connected to the electrode lead 50 downward by the front guide 130 descending down onto the electrode tab 18. Various modifications are possible, such as a separate fixed jig being installed at the lower side of the electrode tab 18 or the lower jig 110 extending to the lower side of the electrode tab 18. The descending operation of the front guide 130 may assist the electrode lead 50 to be stably disposed for when the working roller 70 presses the electrode lead 50 and may prevent excessive movement of the electrode tab 18 to ensure accurate pressing.

The second process S23 include the base jig 100 supporting the lower side of the electrode lead 50. Various alternatives are possible, such as the first process S21 and the second process S23 being performed sequentially or simultaneously. Because the electrode lead 50 is disposed at the upper side of the lower jig 110 and the bottom jig 120 that constitute the base jig 100, the electrode lead 50 is restricted from moving downward when it is pressed by the working roller 70. In the second process S23, the support of a lower portion of the electrode lead 50 may be ensured so that the softening operation by the pressing of the working roller 70 is effective.

The third process S24 may include the working roller 70 moving horizontally while pressing the upper side of the electrode lead 50. The working roller 70 rotates while in contact with the upper side of the electrode lead 50 to move horizontally along the electrode lead 50. The electrode lead 50 may be pressed between the working roller 70 and the base jig 100, and, thus, the softening operation of the electrode lead 50 occurs. In the third process S24, a moving speed and pressing strength of the working roller 70 may have a great influence on a degree of the softening of the electrode lead 50, and, thus, optimal conditions may be set. A speed range of the working roller 70 according to embodiments may be about 5 mm/s to about 20 mm/s, and the pressing strength may be about 5 N/mm² to about 20 N/mm². However, the present disclosure is not limited to these examples, and the operating conditions of the working roller 70 may be changed depending on a material and thickness of the electrode lead 50.

The softening may refer to a process of reducing rigidity of the electrode lead 50 so that the electrode lead 50 is flexible. The electrode lead 50 may be made of a metal that is initially hard and difficult to be bent. But the electrode lead 50 may be softened through the softening process so that it may be easily bent to a desired angle. The softening may be mainly achieved through heating and pressing. If the working roller 70 moves while pressing the electrode lead 50, the electrode lead 50 may be subjected to a pressure and a small amount of frictional heat may be generated. The heat and pressure slightly deforms the metal structure of the electrode lead 50 causing the metal to be more flexible. The softened electrode lead 50 may be easily bent to a set angle, which thereby improves efficiency in the manufacturing process. In some embodiments, the electrode lead 50 that has undergone the softening process may be maintained at a constant bending angle to reduce an interference with the electrode assembly 10, thereby improving electrical safety. If the electrode lead 50 is bent at an accurate angle, an internal space of the secondary battery 1 may be used more efficiently.

The second pressing process S30 include the working roller 70 pressing the electrode lead 50 and bending the electrode lead 50 to the set angle A. If the working roller 70 is pressed a second time while a portion of the lower side of the electrode lead 50 is supported by the lower jig 110, the working roller 70 may move downward along an upper edge 112 of the lower jig 110, and the electrode lead 50 protruding outward from the lower jig 110 may be bent at the set angle A. The second pressing process S30 may include a restriction process S31, a first moving process S33, and a second moving process S35.

The restriction process S31 may restrict movement of the electrode tab 18 connected to the electrode lead 50 by the front guide 130 descending to the electrode tab 18. Because the front guide 130 descends in the first process S21 of the first pressing process S20 to restrict the movement of the electrode tab 18, the restriction process S31 of the second pressing process S30 may be omitted.

In some embodiments, after the softening operation of the electrode lead 50 is completed, the front guide 130 may ascend and then descend again in the restriction process S31 to restrict the movement of the electrode tab 18. The restriction operation of the front guide 130 may be important in that a position of the electrode tab 18 is fixed while the electrode lead 50 is bent so that the electrode lead 50 is accurately bent.

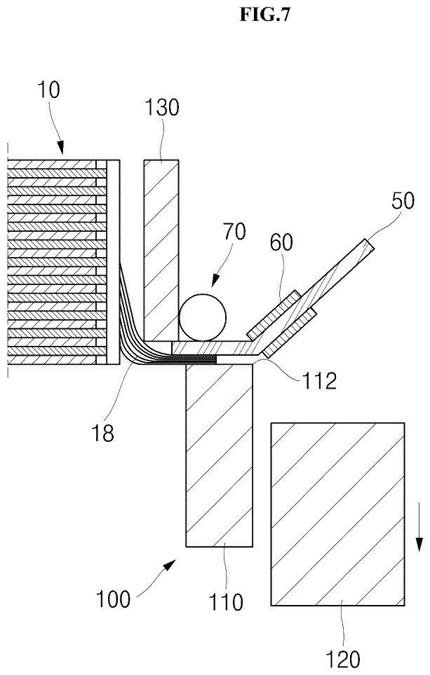

FIG. 7 is a front view of the bottom jig 120 is a lowered position according to embodiments of the present disclosure. As illustrated in FIG. 7, the first moving process S33 may be such that the bottom jig 120 supporting the electrode lead 50 moves downward. Due to the movement of the bottom jig 120, only the lower jig 110 may support the lower side of the electrode lead 50. The bent portion of the electrode lead 50 may be positioned to face an upper edge 112 of the lower jig 110. In the first moving process S33, a descending speed of the bottom jig 120 may have to be adjusted so that the electrode lead 50 is stably bent.

FIG. 8 is a front view of a state in which the electrode lead 50 is bent by movement of the working roller 70 according to embodiments of the present disclosure. As illustrated in FIG. 8, the second moving process S35 may be such that the working roller 70 moves downward to bend the electrode lead 50 in a state in which the electrode lead 50 is hung on the lower jig 110. One side of the electrode lead 50 may be restricted from moving by the front guide 130, and the other side of the electrode lead 50, which extends horizontally, may be pressed downward by the movement of the working roller 70. As the working roller 70 descends to press the other side of the electrode lead 50, the electrode lead 50 is bent into a shape corresponding to the upper edge 112 of the lower jig 110.

The descending speed and pressing strength of the working roller 70 may be set to ensure an accurate bending angle of the electrode lead 50. For example, the descending speed of the working roller 70 may be in a range of about 5 mm/s to about 15 mm/s. As such, the descending speed may provide a sufficient time for the electrode lead 50 to be evenly deformed and prevent heat accumulation in the electrode lead 50. The pressing strength of the descending working roller 70 may vary depending on a material and thickness of the electrode lead 50 but may be set in a range of about 10 N/mm² to about 20 N/mm².

A cross-section of the lower jig 110 may be a rectangular shape, and the electrode lead 50 may be bent into a shape that wraps the upper edge 112 of the lower jig 110. The upper edge 112 of the lower jig 110 may be formed at a right angle, and the electrode lead 50 that is in contact with the upper edge 112 may be bent at about 90° by the pressing of the working roller 70. Because the bending angle of the electrode lead 50 is determined according to the edge shape of the lower jig 110, a design of the lower jig 110 may be significant. The bending angle of the electrode lead 50 is not limited to about 90°, and the bending angle of the electrode lead 50 may be changed depending on installation environments of the electrode lead 50.

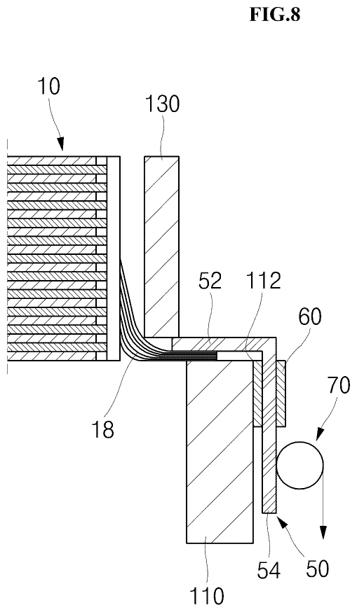

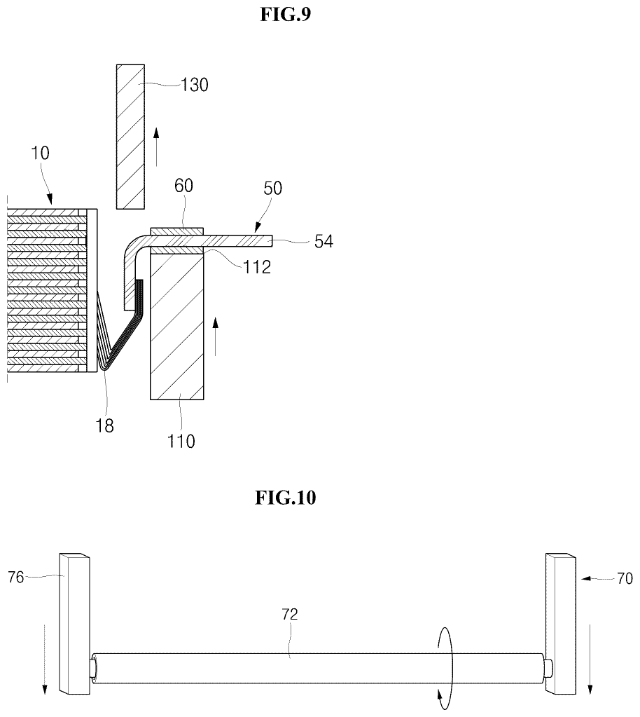

FIG. 9 is a front view of a state in which the electrode lead 50 moves to a front side of the electrode assembly 10 according to embodiments of the present disclosure. As illustrated in FIG. 9, the moving process S40 may be such that the electrode lead 50 moves to the front side of the electrode assembly 10 after the second pressing process S30 is completed. For example, the moving process S40 may include a release process S41 and a jig moving process S43. The moving process S40 may ensure that the electrode lead 50 moves to the position at which an optimal connection is maintained with the electrode assembly 10.

The release process S41 may be such that the front guide 130 ascends to release the restriction of the electrode tab 18. Because the ascending front guide 130 separates from the electrode tab 18, the electrode tab 18 becomes movable. In this process, the front guide 130 that fixes the electrode tab 18 may be released to ensure free movement of the electrode tab 18. As the front guide 130 ascends, an interference with the electrode tab 18 may be minimized.

The jig moving process S43 may be such that the lower jig 110 supporting the electrode lead 50 ascends in a direction toward the electrode assembly 10. As the lower jig 110 supporting the electrode lead 50 ascends, the electrode lead 50 connected to the electrode tab 18 rotates at an angle of about 90° in a counterclockwise direction to a position where it is disposed in front of the electrode assembly 10. The lower jig 110 may allow the electrode lead 50 to move to the front side of the electrode assembly 10 while the lower jig 110 supports the electrode lead 50. The ascending and moving of the lower jig 110 may ensure accurate placement of the electrode lead 50, and a moving path and speed of the lower jig 110 may be set so that the electrode lead 50 is not damaged.

As described above, the electrode lead 50 bent at a right angle may be accommodated inside the case 20 together with the electrode assembly 10 in such a way that problems such as short circuiting. between the electrode lead 50 and the electrode assembly 10 are prevented.

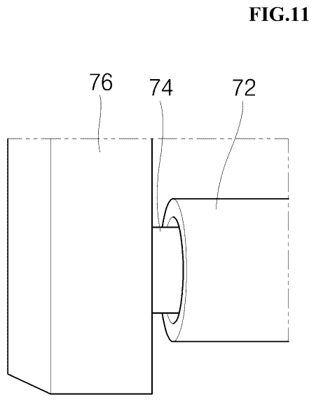

FIG. 10 is a perspective view of the working roller 70 according to embodiments of the present disclosure, and FIG. 11 illustrates an enlarged perspective view of a rotating roller of the working roller 70 according to embodiments of the present disclosure. As shown in FIGS. 10 and 11, the working roller 70 may include a roller body 72, a roller support rod 74, and a roller support 76.

The roller support 76 may be disposed at each of both sides of the roller body 72 and be connected to a hydraulic cylinder that transmits power to the roller support 76. In particular, the roller support 76 may move by various means, such as by being connected to a pneumatic cylinder, a linear moving device, a robot arm, etc. The various driving methods enable flexible application of the working roller 70, and the optimal driving method may be selected depending on the work environment. A hydraulic cylinder may provide high pressure and thus may be useful if strong pressing is required, and the pneumatic cylinder may provide a fast response speed to allow for precise control.

The roller support rod 74 may be provided between the roller supports 76. The roller support rod 74 may have a circular rod shape, and both sides of the roller support rod 74 may be fixed to the roller supports 76. The roller support rod 74 may maintain stability of the working roller 70 and support the working roller 70 to uniformly press the electrode lead 50. Because the material and strength of the roller support rod 74 have an influence on performance of the working roller 70, the roller support rod 74 may be made of a high-strength alloy or a reinforced metal material.

The roller body 72 may be rotatably installed to the outside of the roller support rod 74 to press the electrode lead 50. The roller body 72 may be a portion that is in direct contact with the electrode lead 50 to press the electrode lead 50, and a frictional coefficient of a surface may be appropriately adjusted to enable effective pressing while minimizing the damage to the electrode lead 50. The roller body 72 may be made of a high-strength material and be subjected to a surface treatment (e.g., chrome plating or tungsten carbide coating) to prevent wear. In some embodiments, a rotation speed and rotational force of the roller body 72 may have a significant effect on the softening and bending of the electrode lead 50. Thus, precise control may be achieved.

In some embodiments, the roller body 72 may not be made of a metal but rather made of various materials such as polyurethane and silicone. When the roller body 72 made of various materials is used, an influence on the elongation and bending of the electrode lead 50 may be finely controlled to improve precision of the bending angle.

If the roller body 72 contains polyurethane, the roller body 72 may have high elasticity and wear resistance and evenly distribute the pressure applied to the electrode lead 50. This allows high precision to be maintained during the elongation and bending of the electrode lead 50.

If the roller body 72 contains silicone, the roller body 72 may have excellent flexibility and heat resistance to effectively disperse heat generated during the softening process, thereby preventing overheating of the electrode lead 50 from occurring. Such a roller body 72 may enable the stable bending operation even in high-temperature environments.

In some embodiments, the present disclosure may further include an automatic adjustment roller system. The automatic adjustment roller system may include a sensor, a feedback system, and a control device. The sensor may monitor a position and status of the electrode lead 50 in real time, and the feedback system may receive data from the sensor to transmit a signal to the control device that adjusts a pressure and position of the working roller 70. The control device may process the signal to control the movement of the working roller 70.

The control device may manipulate the hydraulic cylinder, the pneumatic cylinder, or the robotic arm to optimize the position and pressure of the working roller 70. Thus, the pressing strength and position of the working roller 70 may be automatically adjusted, and optimal elongation and bending conditions may be applied to each electrode lead 50.

The automatic adjustment system may significantly improve work efficiency and quality by automatically applying the optimal elongation and bending conditions for each electrode lead 50. An error may be minimized through the real-time monitoring and adjustment functions of the sensor and the feedback system, and a high-precision bending operation may be implemented. The automatic adjustment system may also flexibly respond to various working environments and conditions.

According to other embodiments, a separate working roller 70 is provided for each of the elongation and bending operation of the electrode lead 50. And in some embodiments, each working roller 70 may be divided into a cooling roller and a heating roller that are capable of controlling a temperature of the electrode lead 50. When the cooling roller is used in a process of elongating the electrode lead 50, the elongation operation may be performed while maintaining the rigidity of the electrode lead 50. After the elongation is complete, the heating roller may be used as the second roller. The electrode lead 50 may be softened through the heating roller and then be accurately bent at an angle. The separation of the elongation and bending processes may improve accuracy of each process and maintain consistency in the bending angle. In some embodiments, the temperature of the electrode lead 50 may be adjusted using the cooling and heating rollers to optimize physical properties of the electrode lead 50 and prevent the electrode lead 50 from being damaged.

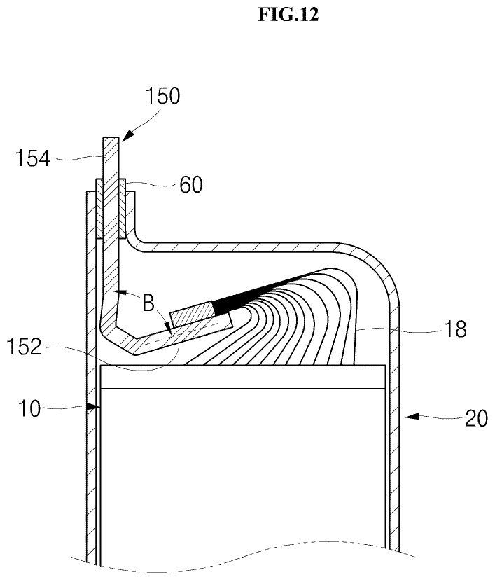

FIG. 12 is a cross-sectional view of an electrode lead 150 is provided inside a case 20 in a state of being bent at an acute angle according to other embodiments. As illustrated in FIG. 12, an electrode lead 150 according to other embodiments may include an extension body 154 extending outward from the case 20, and a connection body 152 bent at a set angle B from the extension body 154. In some embodiments, the angle the electrode lead 150 is bent may be an acute angle. That is, the setting angle B may be less than about 90°.

If the angle formed by the connection body 152 and the extension body 154 is the acute angle, an end of the extension body 154 may be inclined in a direction away from an upper end of the electrode assembly 10 (as shown in FIG. 12), thereby improving electrical safety. The electrode lead 150 bent at the acute angle may be bent to the set angle B by the movement of the working roller 70 while being connected to the electrode tab 18. The electrode lead 150 may be bent to the acute angle by primary pressing of the working roller 70. In some embodiments, if the electrode lead 150 is very rigid, the working roller 70 may move several times to press and bend the electrode lead 150 to the acute angle. For example, the electrode lead 150 may be softened by the primary pressing of the working roller 70 and bent to the acute angle by secondary pressing of the working roller 70.

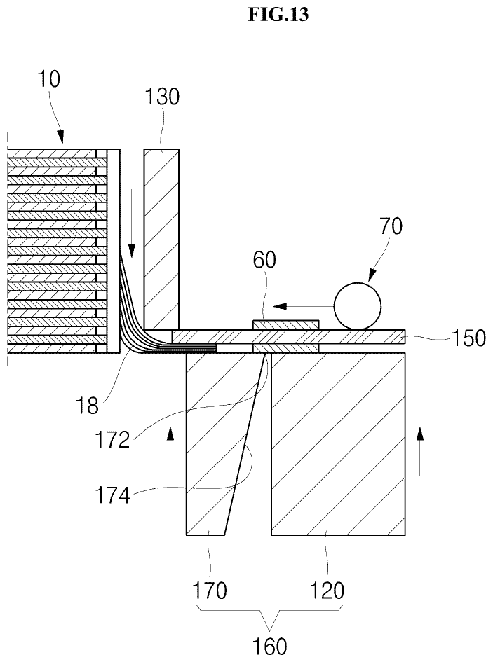

FIG. 13 is a front view of a state in which the electrode lead 150 is softened according to other embodiments of the present disclosure. As illustrated in FIG. 13, the electrode lead 150 may be supported at a lower portion by a base jig 160 for the acute angle.

The base jig 160 according to other embodiments may include a lower jig 170 and a bottom jig 120. A cross-section of the lower jig 170 may have an inverted triangular shape so that the bending angle of the electrode lead 150 is acute. In some embodiments, a front surface 174 of the lower jig 170 (right surface shown in FIG. 13) may be provided as an inclined surface. In some embodiments, an upper edge 172 of the lower jig 170 may be formed at the acute angle, and the electrode lead 150 that is in contact with the upper edge 172 may be bent to the acute angle by the pressing of the working roller 70. As the upper edge 172 is formed at the acute angle, a top surface of the lower jig 170 and the front surface 174 of the jig form the acute angle. Because the electrode lead 150 is bent into a shape that wraps the upper edge 172 of the lower jig 170, the electrode lead 150 may be bent to the acute angle.

Because the working roller 70 presses the upper side of the electrode lead 150 and moves horizontally, the electrode lead 150 may be elongated. Except for the shape of the lower jig 170, this embodiment may be the same as the other embodiments described herein.

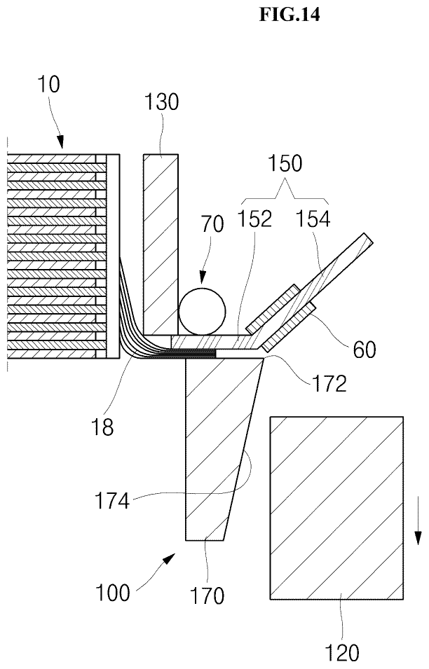

FIG. 14 is a front view of a state in which the bottom jig 120 descends according to other embodiments of the present disclosure. As illustrated in FIG. 14, after the electrode lead 150 is elongated, the bottom jig 120 supporting the electrode lead 150 may move downward. Due to the movement of the bottom jig 120, only the lower jig 170 may support the lower side of the electrode lead 150. The bent portion of the electrode lead 150 may face an upper edge 172 of the lower jig 170.

FIG. 15 is a front view of a state in which the electrode lead 150 is bent due to the movement of the working roller 70 according to other embodiments of the present disclosure. As illustrated in FIG. 15, in a state in which the electrode lead 150 is hung on the lower jig 170, the working roller 70 may move downward and an operation of bending the electrode lead 150 may be performed. One side of the electrode lead 150 may be restricted from moving by a front guide 130 and the other side of the electrode lead 150, which extends horizontally, may be pressed downward by the movement of the working roller 70. As the working roller 70 descends while pressing the electrode lead 150, the electrode lead 150 may be bent an acute angle corresponding to the upper edge 172 of the lower jig 170.

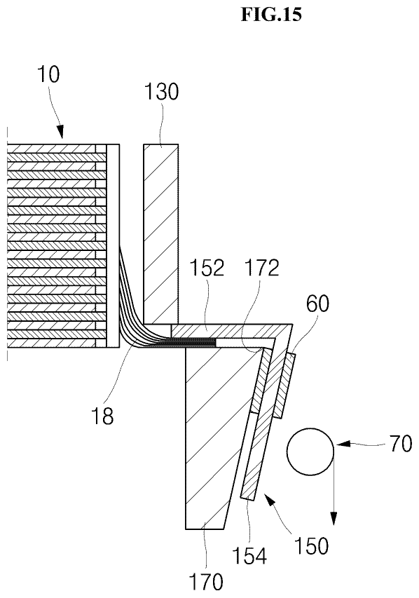

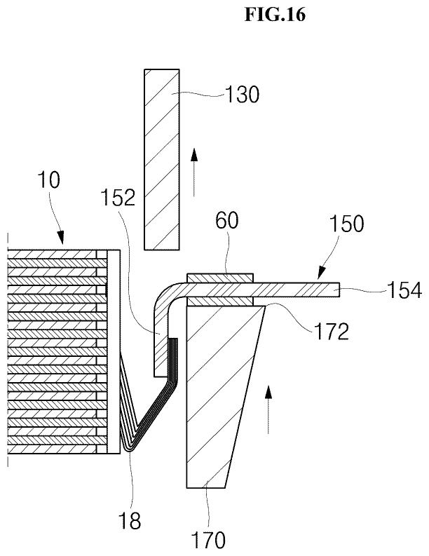

FIG. 16 is a front view of a state in which the electrode lead 150 moves to a front side of an electrode assembly 10 according to other embodiments of the present disclosure. As illustrated in FIG. 16, after the electrode lead 150 is bent at an acute angle, the electrode lead 150 may move to be disposed in front of the electrode assembly 10. After the front guide 130 ascends to release restriction of an electrode tab 18, the lower jig 170 supporting the electrode lead 150 may ascend to move in a direction toward the electrode assembly 10. The electrode lead 150 connected to the electrode tab 18 may rotate at an angle of about 90° in a counterclockwise direction and then may be disposed in front of the electrode assembly 10.

As described above, the electrode lead 150 bent at the acute angle may be accommodated inside the case 20 together with the electrode assembly 10 to thereby prevent problems such as short circuiting between the electrode lead 150 and the electrode assembly 10 from occurring.

Aspects of the electrode assembly 10 according to the present disclosure will be described in more detail.

As the positive electrode active material, a compound capable of reversibly intercalating /eintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GeO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

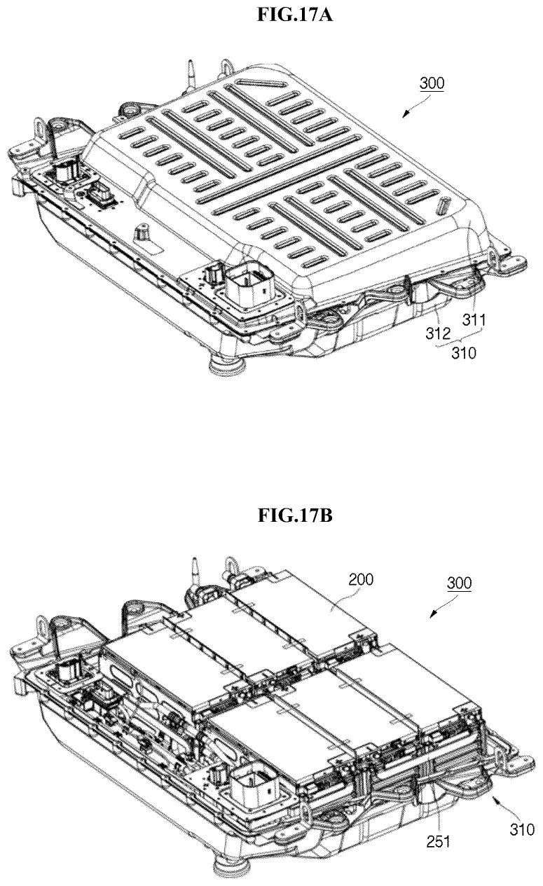

The batteries according to the above-described embodiments may be used to manufacture a battery pack. FIGS. 17A and 17B are perspective views showing a battery pack including the exemplary secondary battery according to the present disclosure. Referring to FIGS. 17A and 17B, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

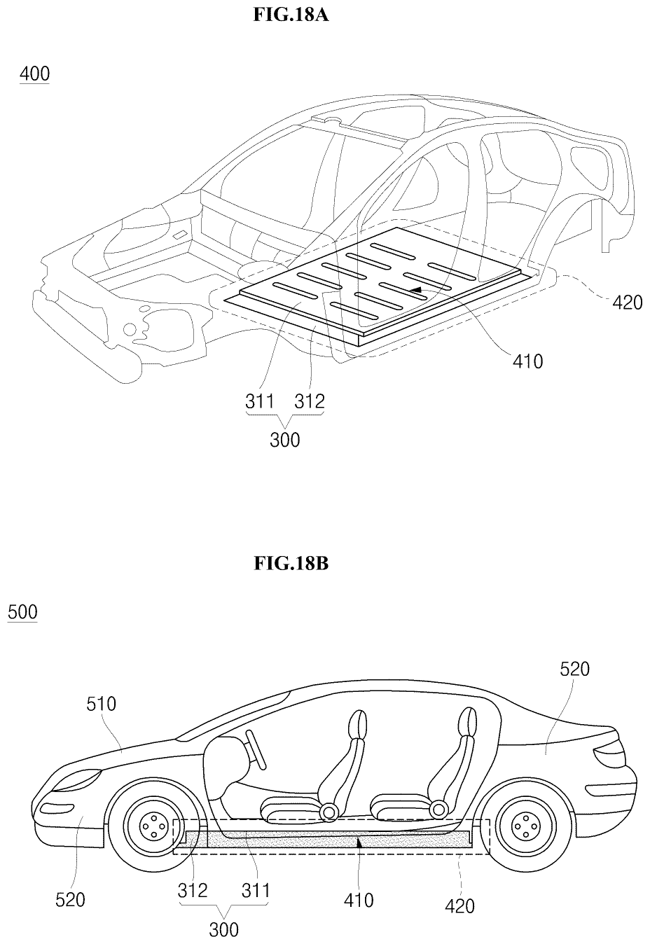

FIGS. 18A and 18B are, respectively, a perspective view and a side view showing vehicles 400 and 500 including the exemplary battery pack 300 according to the present disclosure.

In FIG. 18A, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 18B, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

According to embodiments of the present disclosure, because the bending angle of the electrode lead is acute or a right angle, interference between the electrode lead and the electrode assembly may be prevented to improve the electrical safety of the secondary battery.

According to embodiments of the present disclosure, because the bending of the electrode lead is performed within a set angle to more efficiently utilize the internal space of the battery, the performance and efficiency of the secondary battery may be improved.

In addition, according to some embodiments of the present disclosure, because a method for softening and bending the electrode lead uses a roller, the safety of the manufacturing process may be improved, and the production efficiency may be improved.

However, the effects achievable through the present disclosure are not limited to those described above, and other technical effects not mentioned can be clearly understood by those skilled in the art from the description herein.

Although a few embodiments of the present disclosure have been shown and described, it would be appreciated by those skilled in the art that various changes and modifications may be made in this embodiment without departing from the principles and spirit of the disclosure.

What is claimed is

1. A secondary battery comprising:
an electrode assembly in which a positive electrode plate, a negative electrode plate, and a separator are stacked;
a case that wraps around the outside of the electrode assembly; and
an electrode lead having a first side electrically connected to an electrode tab of the electrode assembly and a second side extending outward from the case, the electrode lead including a bent portion positioned inside of the case,
wherein the electrode lead comprises:
a connection body fixed to the electrode tab; and
an extension body bent at a set angle from the connection body and extending outward from the case,
wherein the set angle is equal to or less than about 90°.

2. The secondary battery as claimed in claim 1, wherein the electrode lead is bent to the set angle by movement of a working roller while the electrode lead is connected to the electrode tab.

3. The secondary battery as claimed in claim 1, wherein the electrode lead is softened by being pressed by the working roller.

4. The secondary battery as claimed in claim 3, wherein the pressing by the working roller is a first pressing, and after the pressing by the working roller, the electrode lead is bent to the set angle by a second pressing by the working roller.

5. The secondary battery as claimed in claim 4, wherein a lower side of the electrode lead is supported by a lower jig and a bottom jig during the first pressing by the working roller.

6. The secondary battery as claimed in claim 4, wherein, in the second pressing by the working roller, a portion of a lower side of the electrode lead is supported by the lower jig, and the working roller moves along an upper edge of the lower jig to bend the electrode lead protruding to outside of the lower jig.

7. The secondary battery as claimed in claim 6, wherein the upper edge of the lower jig is formed at a right angle, and the electrode lead that is in contact with the upper edge is bent at about 90° by the second pressing of the working roller.

8. The secondary battery as claimed in claim 6, wherein the upper edge of the lower jig is formed at an acute angle, and the electrode lead that is in contact with the upper edge is bent to an acute angle by the second pressing of the working roller.

9. The secondary battery as claimed in claim 1, further comprising an insulating tape disposed between the electrode lead and the case and being fixed to an outside of the electrode lead.

10. A method for manufacturing a secondary battery, the method comprising:
a connection process of connecting an electrode lead to an electrode tab that protrudes outward from an electrode assembly in which a positive electrode plate, a negative electrode plate, and a separator are stacked;
a first pressing process of pressing the electrode lead by movement of a working roller to soften the electrode lead; and
a second pressing process of pressing the electrode lead by the working roller to bend the electrode lead to a set angle.

11. The method as claimed in claim 10, wherein the first pressing process comprises:
a first process of pressing the electrode tab connected to the electrode lead downward by a descending front guide;
a second process of supporting the electrode lead by a base jig; and
a third process of pressing the electrode lead upward by the working roller.

12. The method as claimed in claim 11, wherein the base jig comprises:
a lower jig supporting a first side of the electrode lead connected to the electrode tab; and
a bottom jig disposed at a side of the lower jig to support a second side of the electrode lead.

13. The method as claimed in claim 12, wherein the second pressing process comprises:
a first moving process of moving the bottom jig supporting the electrode lead downward; and
a second moving process of moving the working roller downward to bend the electrode lead while the electrode jig is hung on the bottom jig.

14. The method as claimed in claim 13, wherein the lower jig has a rectangular cross-section, and the electrode lead is bent in a shape that wraps an upper edge of the lower jig.

15. The method as claimed in claim 14, wherein a bending angle of the electrode lead is about 90°.

16. The method as claimed in claim 13, wherein the lower jig has an inverted triangular cross-section, and the electrode lead is bent in a shape that wraps an upper edge of the lower jig.

17. The method as claimed in claim 16, wherein a bending angle of the electrode lead is an acute angle.

18. The method as claimed in claim 13, wherein the second pressing process further comprises a restriction process that restricts movement of the electrode tab connected to the electrode lead due to the descending of the front guide.

19. The method as claimed in claim 10, further comprising a moving process of moving the electrode lead to a position in front of the electrode assembly after the second pressing process is complete.

20. The method as claimed in claim 19, wherein the moving process comprises:
a release process of releasing restriction of the electrode tab by ascension of a front guide; and
a jig moving process of moving a jig in a direction toward the electrode assembly.
